(19) United States
(12) Patent Application Publication
(10) Pub. No.: US 2010/0065361 A1
(43) Pub. Date: Mar. 18, 2010

(54) Battery Powered Vehicle Control Systems and Methods

(75) Inventors: Ki Y. Nam, Newport Beach, CA (US); Kenneth Tien Cao, Laguna Niguel, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: T3 MOTION, INC., Costa Mesa, CA (US)

(21) Appl. No.: 12/212,501

(22) Filed: Sep. 17, 2008

(51) Int. Cl. B62D 61/08

(52) U.S. Cl. 180/211; 340/474; 701/93; 348/148

(57) ABSTRACT

Battery powered vehicle control system and methods which allow programming the characteristics and performance of the vehicle as suitable for its then intended use. Programming is through a separate switch which can be made inoperative to the vehicle user, and can be used to program maximum speed, lights, siren and other functions. A steering sensor may be used on the steering mechanism to automatically limit speed in turns. Other characteristics and features of the control system are disclosed.

### BACKGROUND OF THE INVENTION

1. Field of the Invention

The present invention relates to the field of control systems and methods for battery powered vehicles.

2. Prior Art

Battery powered vehicles of various sizes and designs are well known in the prior art. One such vehicle is the three-wheeled vehicle shown in FIGS. 1a and 1b. This vehicle is manufactured by T3 Motion, Inc., assignee of the present invention. This vehicle is extremely versatile, in that it enjoys excellent range without recharging, can turn essentially in its own length, and may be used indoors and outdoors. It is ideal for law enforcement/security purposes, as it elevates the operator above pedestrians, giving much greater surveillance/tracking capabilities than a normal sit-down cart type vehicle. However, because of its versatility, proper control is essential, and control limits are desirable, particularly in certain applications. For instance, it is desirable to have greater speed capabilities in airport parking lots than in the terminal itself, or greater speed capabilities in shopping center parking lots than in the shopping center itself. Also vehicles, whether three wheeled vehicles or four wheeled vehicles, need some limits on high speed turns. These are merely some examples where an automatic control system would be useful.

### BRIEF DESCRIPTION OF THE DRAWINGS

FIGS. 1a and 1b are views of a three wheeled electric vehicle in which the preferred embodiment of the present invention is used.

FIG. 2 is a block diagram of a preferred control system for the vehicle of FIG. 1.

FIG. 3 is a diagram illustrating the programming of the control system.

FIGS. 4a, 4b and 4c illustrate the operation process for the vehicle and control system.

### DETAILED DESCRIPTION OF THE PREFERRED EMBODIMENTS

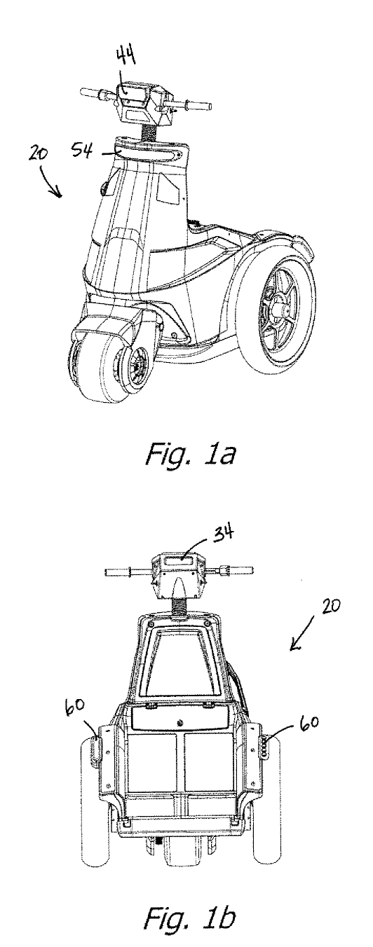

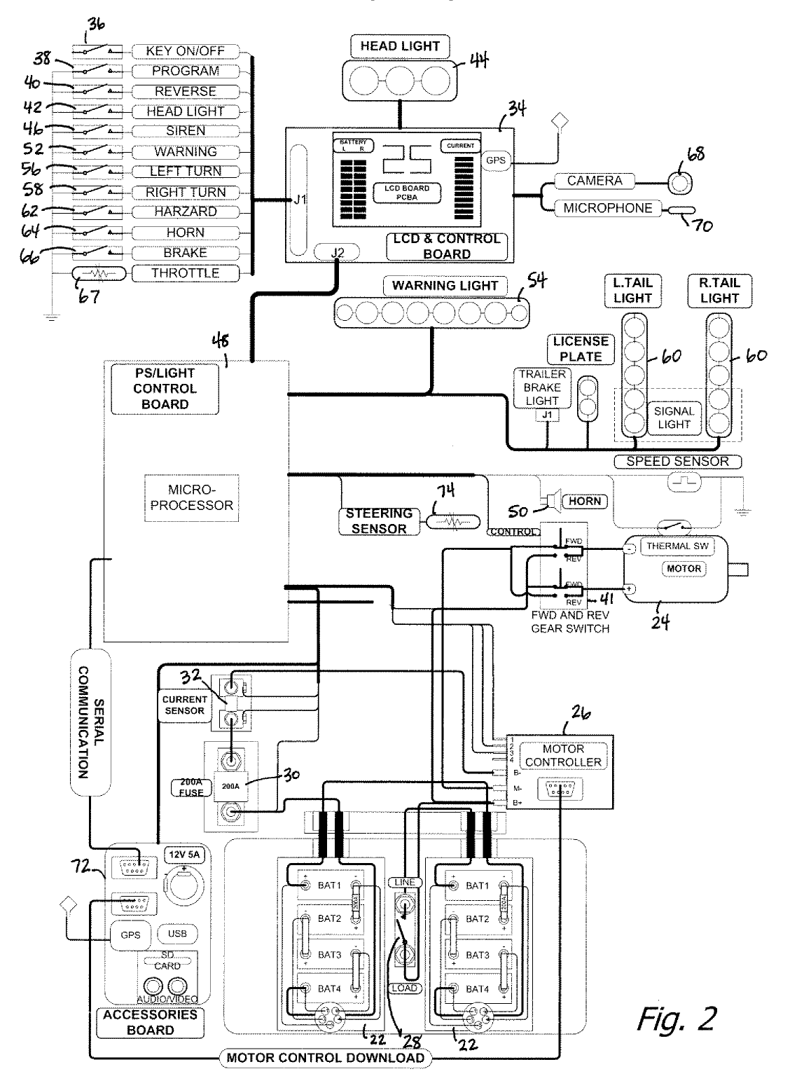

First referring to FIG. 2, a block diagram of the battery powered vehicle control system of a preferred embodiment may be seen. The vehicle 20 of FIGS. 1a and 1b is powered through two removable rechargeable batteries 22 which power motor 24, driving the front wheel of vehicle 20 through motor controller 26. The batteries have a main ON/OFF power switch 28 which powers the system through a fuse 30 and a low resistance current sensing resistor 32. The vehicle 20 has a LCD display and control board 34, the display being visible to the operator, and as shall subsequently be seen, being used both for an instrument panel during operation of the vehicle and for programming various characteristics of the vehicle. The vehicle of course is steered in the same manner as a tricycle, and controlled through a plurality of electrical controls, mostly switches, many of which are accessible on the handle bars of the vehicle for convenient operation by the operator. The main controls are listed at the upper left of FIG. 2, specifically an ON/OFF key switch and a second key switch 38 for programming the system. This allows a supervisor to program the vehicle in accordance with its present assignment, and to effectively lock that program in place so that the same cannot be changed by the operator. In that regard the programming, once entered, is stored in flash memory so that the same is retained even if switch 28 is opened. Accordingly the programming will be maintained if power is terminated, such as by removal of the battery for exchange by recharged batteries, etc. until such time as the program may be intentionally changed. The controls include a reverse switch 40 that operates solid state switch 41 which reverses the polarity of any power provided to motor 24. A headlight switch 42 controls headlights 44, in the preferred embodiment LED lights, also visible in FIG. 1a. As may be seen in FIG. 1a, the headlights 44 are mounted in the center of the handlebars and in a preferred embodiment are housed in a compartment rotatable about a horizontal axis. Accordingly the headlights can also be used as search lights, with the horizontal scan controlled by the vehicle's steering and a vertical scan by manual rotation of the headlight compartment about that horizontal axis parallel to the axis of the front wheel.

The controls further include a siren switch 46 which controls siren type sounds provided under microprocessor control in the light control board 48 to the horn 50. The controls further include a warning light switch 52 which controls 8 warning lights 54 at the front of the vehicle, as may be seen in FIG. 1a. These warning lights are controlled through the light control board 48, again under microprocessor control. The controls further include a left turn switch 56 and a right turn switch 58, each of which controls a respective two lights in the left and right taillight groups 60, also visible in FIG. 1b. The controls further include a hazard light switch 62 which controls the flashing of some warning lights 54 and taillights 60. There is also a horn switch 64 for providing conventional horn sounds through horn 50. There is also a brake switch 66, not normally used for braking but rather for holding the vehicle on substantial inclines once stopped by hand operated hydraulic brakes, as on a modern motorcycle. There is also a throttle control 67, which is a potentiometer type proportional control which controls the motor controller 26 like a throttle on a motorcycle.

During normal operation of the vehicle, the display device, such as an LCD display, will display such things a speed, state of battery charge of each battery, present current usage, and GPS location through a GPS unit associated therewith.

The vehicle also includes a video camera 68 and microphone 70, which are coupled electrically to the accessories board 72, which provides digital sound and image storage, together with time and GPS location through a second GPS unit associated therewith. The video camera is either mounted on the vehicle, or on a helmet worn by the operator to better record what the operator sees. The accessories board 72 can provide video and audio outputs recorded in flash memory on/or plugged into the PS/light control board, provide a speaker output responsive to an output of the light control board or a microphone input, and a 12 volt cigarette plug for an accessory device (3 A up to 15 A capacity). The PS/light control board includes, among other things, a G sensor for sensing 3-axis acceleration, a time stamp and a data logger that records time, speed, position, location, battery condition and current, and warning alarm condition.

Also shown in FIG. 2 is a steering sensor which senses the angle of the steering mechanism from a straight ahead position. As shall subsequently be seen, this is used to limit the vehicle speed by disabling or reducing throttle input in accordance with a turn being executed.

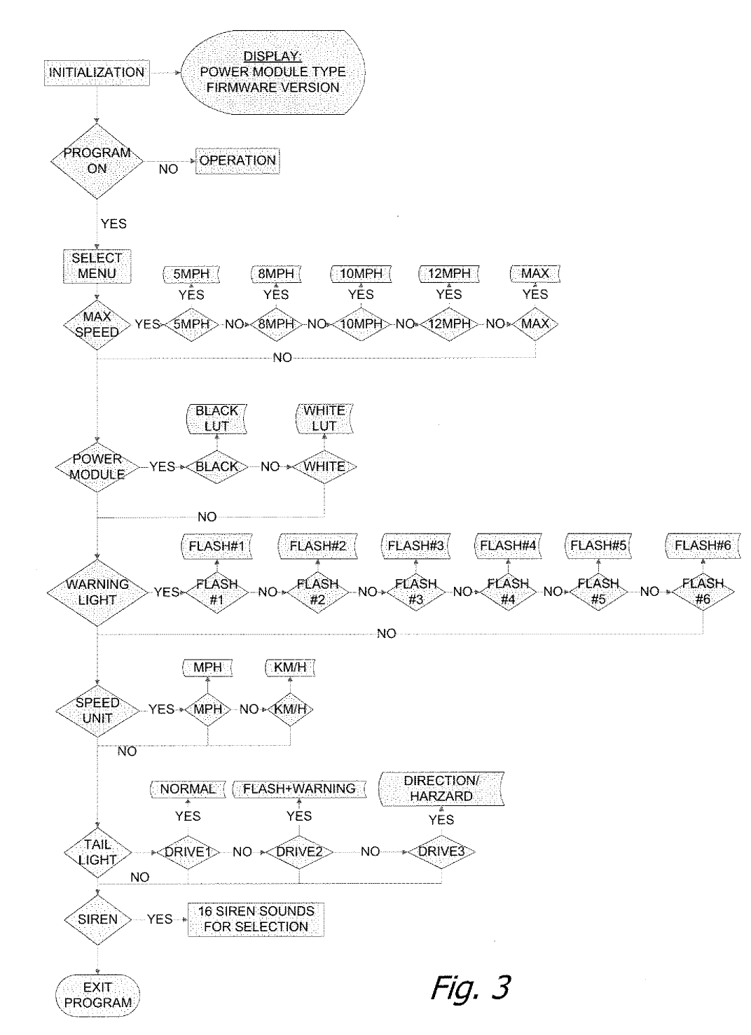

Now referring to FIG. 3, the programming of the control system may be seen. Programming is done through the horn button. Momentary depression of the horn button advances through the programming menu (other controls and prompts may be used), while depression of the horn button for a longer period selects the menu item, as per instructions displayed on the LCD display 24. When power is on (charged batteries in the vehicle and power switch 28 closed), the system may be programmed by turning key switch 38 on. As may be seen in FIG. 3, the first item for programming is the maximum speed. The selections in an exemplary embodiment are 5 mph, 8 mph, 10 mph and 12 mph, though if none of these are selected, maximum speed is selected, which in the exemplary embodiment is approximately 25 mph. The available selections for programming the maximum speed allow automatic enforcement of maximum speed in accordance with operating environment. By way of example, policing within a crowded shopping center or airport terminal might warrant the lowest limit, while policing the same areas after hours may warrant a much higher limit. Outside policing, particularly after hours, may warrant no programmed speed limit, i.e., maximum speed.

The next item to be programmed is the power module. Two lookup tables are provided, one called black and one called white. These labels are simply lookup tables for ordinary and high energy batteries, the proper one being selected so that battery state of charge, etc. will read properly.

The next items to be programmed are the warning lights 54. These lights may be programmed with any of 6 flashing patterns (simple flash, scanning side to side, etc.), again generally selected based on the intended use of the vehicle. Then the speed unit is programmed to display speed either in miles per hour (MPH) or kilometers per hour (KM/H). Then the tail light is programmed to operate as a conventional tail light, to flash together with the warning lights or to operate as direction/hazard lights. Finally, the siren sound is programmed, there being 16 choices of siren sounds for selection, effecting both the intensity and characteristic of the sound. When programming is finished, the programming switch is turned off, which will automatically put the vehicle in the operating mode when key switch 36 is turned on.

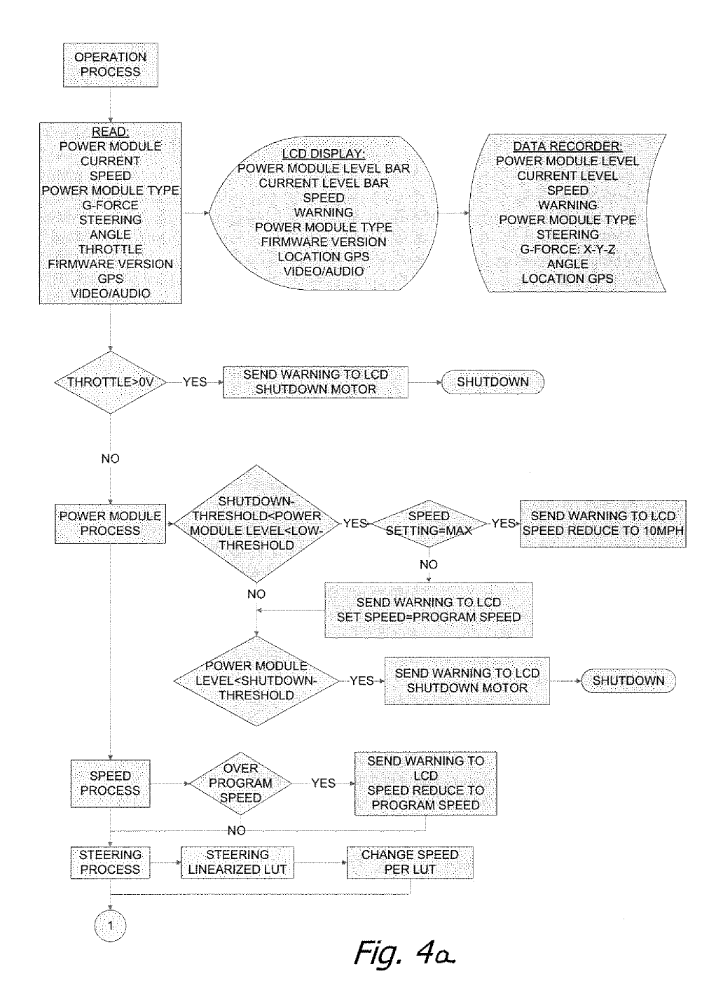

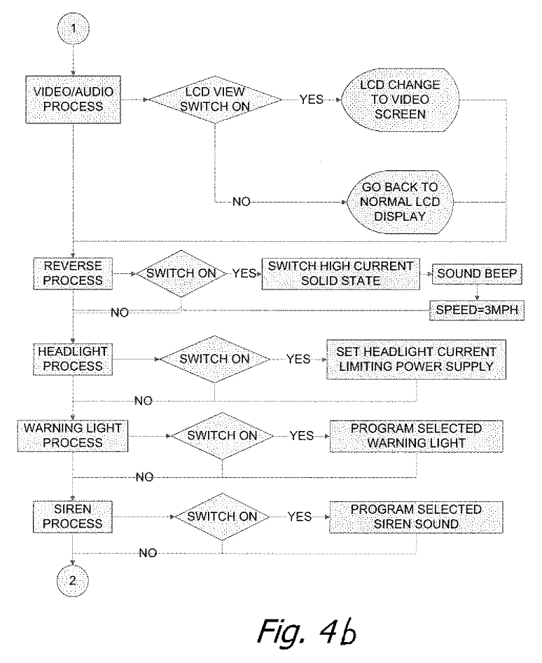

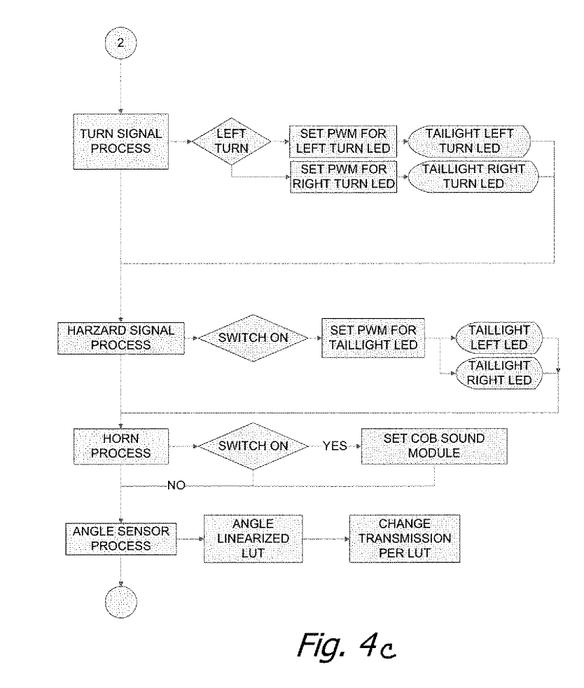

The operation process when key switch 36 is turned on is shown in FIGS. 4a, 4b and 4c, FIG. 4a illustrating the start of the operation process of an exemplary embodiment. Initially various parameters are read, some of which are displayed on the LCD display and some of which are recorded on the data logger. Then if the throttle setting is above zero volts, a warning is displayed on the LCD display and the motor is shutdown. This prevents the vehicle from unexpectedly lurching in the event the throttle is not at the motor off position when the key switch 36 is first turned on. Then the power module is tested to see if the battery charge (power module) level is adequate for vehicle operation. Three charge conditions are used, namely a shutdown level below which the vehicle motor will not operate, a low threshold which is above the shutdown level, and a normal level which is above the low threshold. If it is determined that the power module level is between the shutdown threshold and the low threshold and the speed limit programmed is the maximum speed, the maximum speed is automatically reduced and a warning is displayed on the LCD display. If the maximum speed is not the programmed speed limit, the speed limit setting is not changed, though the power module level warning is still displayed. If it is determined that the shutdown threshold is not between the shutdown threshold and the low threshold, but instead is less than the shutdown threshold, then a power module level warning is still displayed and the motor is shutdown, disabling the vehicle operation. Otherwise normal operation is enabled.

Then the speed is monitored, and if it exceeds the programmed speed limit, a warning is displayed on the LCD display and the speed is reduced to the programmed speed. Even if the speed is within the programmed speed limit, the steering sensor is monitored, and a lookup table is used to determine the maximum speed for the turn presently being executed. If the current speed exceeds the maximum speed for the turn presently being executed, the speed is automatically reduced, overriding the throttle control sensor 67 (FIG. 2). A lookup table is used, as the safe speed for a turn is not a linear function of the angle of the steering mechanism.

The operation process is continued in FIG. 4b. As shown therein, the LCD view switch on the touch screen is tested, and if on, the LCD data display screen is switched to a video screen to display the output of the video camera, and the camera 68 and microphone 70 are turned on and their outputs recorded. Otherwise the LCD data screen displays data as previously described.

Then the reverse switch is tested, and if on, the reverse solid state switch 41 (FIG. 2) is activated, and a beeping sound is generated through the horn 52. Then the headlight switch, the warning light switch and the siren switch are tested, and each controlled by the state of the respective switch. In the case of the headlights, a current limiting power supply is used to limit the total current to the headlights. In the case of the warning lights and the siren, these are controlled in accordance with their respective programmed operating modes.

FIG. 4c continues the operation process with the testing of the turn signal switches 56 and 58, flashing the appropriate turn signal if either turn signal switch is one. Then the hazard signal switch 62 is tested, and if on, both left and right turn signal lights are flashed in unison. Then the horn switch 64 is tested, and if on, the horn 50 is activated with a conventional horn type sound. Finally, the output of the angle or steering sensor 74 on the steering mechanism is compared with a lookup table value, and if the speed is excessive for the present angle, the throttle control is overridden, and the speed is automatically reduced.

The foregoing operation process is successively repeated at microprocessor speed, so that any delay between the operation of a particular control and the initiation of the action commanded by that control in imperceptible. In the preferred embodiment, all lights are LED lights, used because of their high efficiency to conserve battery power.

The present invention, the preferred embodiment of which has been described, has a number of aspects, which aspects may be practiced alone or in various combinations or sub-combinations, as desired. While a preferred embodiment of the present invention has been disclosed and described herein for purposes of illustration and not for purposes of limitation, it will be understood by those skilled in the art that various changes in form and detail may be made therein without departing from the spirit and scope of the invention as defined by the full breadth of the following claims.

What is claimed is:

1. A vehicle comprising:
a three wheeled battery powered vehicle having a pair of back wheels and a front wheel steerable through a steering mechanism;
the front wheel being powered by a battery powered motor as controlled by a vehicle controller;
a manually operated motor speed control coupled to the vehicle controller for control of the vehicle speed;
a sensor coupled to the steering mechanism to sense rotation of a steering mechanism;
the sensor being coupled to the vehicle controller to limit the maximum speed of the three wheeled battery powered vehicle responsive to rotation of the steering mechanism.

2. The vehicle of claim 1 wherein the sensor comprises a plurality of switches each responsive to a different rotation of the steering mechanism.

3. The vehicle of claim 1 wherein the sensor is a continuous sensor.

4. The vehicle of claim 1 further comprised of a plurality of switches, the vehicle controller being programmable to limit the speed of the vehicle to any of a plurality of speed limits through operation of the switches.

5. The vehicle of claim 4 further comprised of a display, wherein the vehicle controller is programmable using prompts displayed on the display.

6. The vehicle of claim 5 wherein one of the switches is a key switch selecting between a vehicle programming mode and a vehicle operating mode, the key switch being in the vehicle operating mode when the key is not in the key switch.

7. The vehicle of claim 6 wherein when in the operating mode, the display displays a number of vehicle operating conditions, including speed and battery condition.

8. The vehicle of claim 7 wherein the vehicle includes a video camera, and wherein when the vehicle is in the operating mode, the video camera may be turned on and the display switched to a video mode to display the video camera images.

9. The vehicle of claim 8 wherein the vehicle includes storage for storing audio and video images.

10. The vehicle of claim 9 wherein the storage includes removable flash memory.

11. The vehicle of claim 5 wherein the vehicle includes a plurality of warning lights, and wherein one programmable parameter is the operation of the warning lights.

12. The vehicle of claim 5 wherein the vehicle includes a siren, and wherein the noise created by the siren is programmable.

13. A vehicle comprising:
a three wheeled battery powered vehicle having a pair of back wheels and a front wheel steerable through a steering mechanism;
the front wheel being powered by a battery powered motor as controlled by a vehicle controller;
a manually operated motor speed control coupled to the vehicle controller for control of the vehicle speed;
a display;
a plurality of switches, one of the switches being a key switch selecting between a vehicle programming mode and a vehicle operating mode, the key switch being in the vehicle operating mode when the key is not in the key switch, the vehicle controller being programmable to limit the speed of the vehicle to any of a plurality of speed limits through operation of the switches using prompts displayed on the display.

14. The vehicle of claim 13 wherein when in the operating mode, the display displays a number of vehicle operating conditions, including speed and battery condition.

15. The vehicle of claim 13 wherein the vehicle includes a plurality of warning lights, and wherein one programmable parameter is the operation of the warning lights.

16. The vehicle of claim 15 wherein the vehicle includes a siren, and wherein the noise created by the siren is programmable.

17. The vehicle of claim 13 wherein the vehicle includes a video camera, and wherein when the vehicle is in the operating mode, the video camera may be turned on and the display switched to a video mode to display the video camera images.

18. The vehicle of claim 17 wherein the vehicle includes storage for storing audio and video images.

19. The vehicle of claim 18 wherein the storage includes removable flash memory.
